(19) United States
(12) Patent Application Publication
(10) Pub. No.: US 2018/0374646 A1
(43) Pub. Date: Dec. 27, 2018

(54) WIDEBAND COUPLING CAPACITOR

(71) Applicant: VISHAY ISRAEL LTD., Petach Tiqwa (IL)

(72) Inventors: Brian Ward, Raleigh, NC (US); Eli Bershadsky, Haifa (IL); Guy Burshteyn, Afula (IL); John Rogers, Seymour, CT (US); Oded Shiek, Moshav Regba (IL)

(73) Assignee: VISHAY ISRAEL LTD., Petach Tiqwa (IL)

(21) Appl. No.: 16/018,685

(22) Filed: Jun. 26, 2018

Related U.S. Application Data
(60) Provisional application No. 62/524,773, filed on Jun. 26, 2017.

(51) Int. Cl. H01G 4/30; H01G 4/248; H01G 4/12

(52) U.S. Cl. CPC H01G 4/30; H01G 4/12; H01G 4/248

(57) ABSTRACT

A multilayer ceramic coupling capacitor having a low insertion loss across a wideband frequency range is provided herein. In an example, a multilayer ceramic capacitor (MLCC) includes a body comprising top and bottom surfaces, first and second opposite ends, and electrode and dielectric layers. The MLCC also includes first and second terminals attached to the ends, and main block layer electrodes within the body configured in an alternating manner such that a first of the main electrodes is in electrical communication with the first terminal and extends from one end inwardly, and a next of main electrodes is in electrical communication with the second terminal and extends from an opposite end inwardly. In addition, the MLCC includes a first shield electrode in electrical communication with the first terminal and extending from the first end inwardly, positioned between the main electrodes and a lower surface of the body.

### CROSS REFERENCE TO RELATED APPLICATION

This application claims the benefit of U.S. Provisional Patent Application No. 62/524,773, filed Jun. 26, 2017, the entire contents of which is hereby incorporated by reference as if fully set forth herein.

### FIELD OF INVENTION

This application relates to the field of electronic components, and more specifically, capacitors and methods of making capacitors.

### BACKGROUND

Multilayer ceramic capacitors (which may be also referred to as MLCCs) generally have alternating layers of ceramic dielectric material and conductive electrodes. Various types of dielectric materials and metal electrodes can be used and various types of physical configurations have been used for such capacitors. Examples of MLCCs are shown and described in U.S. Pat. Nos. 7,336,475 and 8,238,075, the entire contents of which are incorporated by reference herein.

Insertion loss refers to the loss or reduction in power through a device, such as a capacitor. Insertion loss may be determined by measuring scattering parameters (which may also be referred to as S-parameters). Two-terminal capacitors may be tested by measuring one or more of four S-parameters, such as S21, S12, S11 and S22. S21 measures the fraction of power applied to terminal 1 that is emitted from terminal 2, while S12 measures the fraction of power applied to terminal 2 that is emitted from terminal 1. Moreover, S11 is a reflective parameter which, measuring the fraction of power applied to terminal 1 that is reflected back to terminal 1. Similarly, S22 measures the fraction of power applied to terminal 2 that is reflected back to terminal 2. Each of S21 and S12 are often referred to as insertion loss. Insertion loss may be measured over a range of frequencies. What is needed is an MLCC with enhanced insertion loss characteristics over a wide range of frequencies.

### SUMMARY

A multilayer ceramic coupling capacitor having a low insertion loss across a wideband frequency range is provided herein. In an example, a multilayer ceramic capacitor (MLCC) is provided which includes a body comprising a top surface, a bottom surface, first and second opposite ends, and a plurality of electrode layers and dielectric layers. The MLCC also includes first and second terminals attached to the first and second ends of the body. Further, the MLCC includes a plurality of main block layer electrodes within the ceramic capacitor body configured in an alternating manner such that a first of the plurality of main block layer electrodes is in electrical communication with the first terminal and extends from one end of the ceramic capacitor body inwardly, and a next of the plurality of main block layer electrodes is in electrical communication with the second terminal and extends from an opposite end of the ceramic capacitor body inwardly. In addition, the MLCC includes at least one first shield electrode in electrical communication with the first terminal and extending from the first end of the ceramic capacitor body inwardly, the first shield electrode positioned between the main block layer electrodes and a lower surface of the body.

In another example, a method of manufacturing an MLCC is provided. The method includes forming a ceramic capacitor body from a plurality of electrode layers and dielectric layers and attaching first and second external terminals on opposite ends of the ceramic capacitor body. The plurality of electrode layers are configured in an alternating manner such that a first of the plurality of active electrodes extends from one end of the ceramic capacitor body inwardly and a next internal active electrode extends from an opposite end of the ceramic capacitor body inwardly. At least one first shield electrode is provided, and may be extending from one of the terminals inwardly. The shield electrode is spaced at a distance from the plurality of electrode layers, and is positioned adjacent a surface of the capacitor body.

In a further example, the MLCC has a low insertion loss of approximately S21<0.5 dB over a wideband frequency range of about 16 kHz to about 40 GHz or greater. Alternatively, the MLCC has a low insertion loss of approximately S21<0.5 dB over a wideband frequency range of about 28 kHz to about 20 GHz. Further, the first shield electrode may be positioned closer to the lower surface of the body than to a lower-most of the plurality of main block layer electrodes. In addition, the distance from the first shield electrode to a lower-most of the plurality of main block layer electrodes may be approximately the same as the distance from the first shield electrode to the lower surface of the body. Moreover, the first shield electrode may be spaced at a distance from a lower-most of the plurality of electrodes that is greater than the distance between any two of the plurality of electrodes of the main block layer. Additionally, the first shield electrode may be spaced at a distance from a lower-most of the plurality of electrodes that is the same or similar to the distance between any two of the plurality of electrodes of the main block layer.

In another example, the MLCC has a second shield electrode in electrical communication with the first terminal and extending from the first end of the ceramic capacitor body inwardly, the second shield electrode positioned between the main block layer electrodes and the first shield electrode. The second shield electrode may be positioned closer to the first shield electrode than to the main block layer electrodes.

In still another example, the MLCC has a third shield electrode in electrical communication with the second terminal and extending from the second end of the ceramic capacitor body inwardly, the third shield electrode positioned between the main block layer electrodes and the top surface of the body. In yet another example, the MLCC has a fourth electrode in electrical communication with the second terminal and extending from the second end of the ceramic capacitor body inwardly, the second fourth electrode positioned between the third shield electrode and the top surface of the body.

### BRIEF DESCRIPTION OF THE DRAWINGS

A more detailed understanding can be had from the following description, given by way of example in conjunction with the accompanying drawings wherein:

FIG. 1 illustrates a cross-sectional view of a capacitor according to an embodiment the invention.

FIG. 2 shows a graph illustrating insertion loss in connection with an embodiment of a capacitor according to the invention.

FIG. 3 shows a graph illustrating insertion loss as a function of distance between shield electrodes and the lower surface of the capacitor body.

FIG. 4 shows a graph illustrating the effect of loop inductance simulated as a parallel element across a series capacitor model according to the present invention.

FIG. 5 illustrates a cross-sectional view of a capacitor according to an embodiment the invention.

FIG. 6 illustrates a cross-sectional view of a capacitor according to an embodiment the invention.

FIG. 7 illustrates a cross-sectional view of a capacitor according to an embodiment the invention.

### DESCRIPTION OF THE INVENTION

Generally, the present invention provides for a multilayer ceramic capacitor having a low insertion loss of approximately S21<0.5 dB over a wideband frequency range of about 16 kHz to about 40 GHz or greater. A preferred frequency range may be about 28 kHz to about 20 GHz, but it should be appreciated that the parameters of the invention are not limited to that range. A multilayer ceramic capacitor according to the invention may generally comprise a plurality of electrodes in a main block layer, and at least one shield electrode between the electrodes of the main block layer and a surface of the capacitor. The capacitor according to the invention may generally achieve low loss coupling characteristics over a wide range of frequencies. In examples provided herein, bulk capacitance and electrode structure extend wideband insertion loss in a desired frequency range.

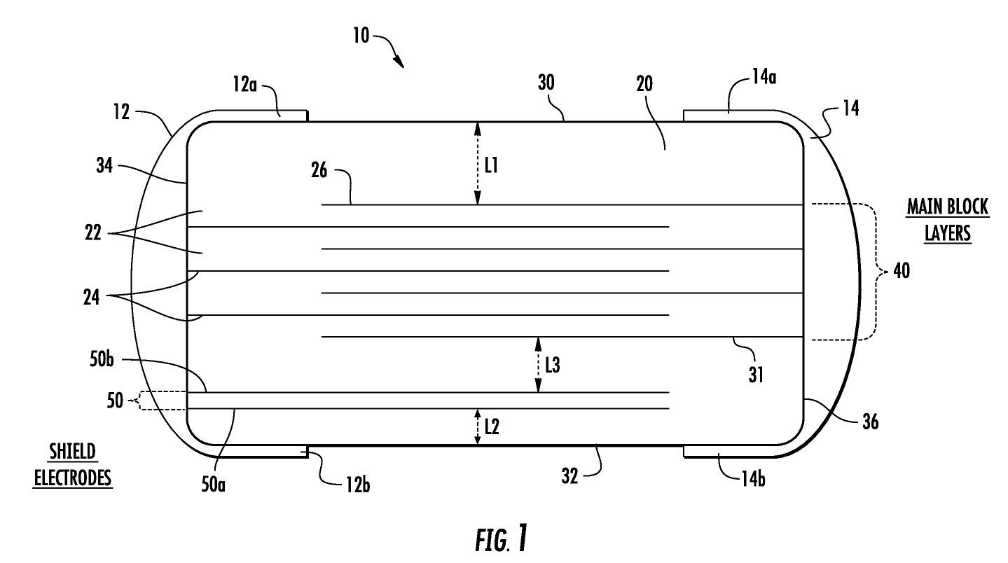

By way of illustration, a multilayer ceramic capacitor 10 according to the teaching of the present invention is shown in cross-section in FIG. 1. The multilayer ceramic capacitor 10 comprises a ceramic body 20 comprising a plurality of dielectric layers 22 and electrode layers 24 formed from internal conductive electrodes 26.

The dielectric material used for the dielectric layers 22 may be formed from materials commonly used in the MLCC industry, and those will be known to persons skilled in the art. The electrodes 26 used for the electrode layers 24 may be formed from materials commonly used in the MLCC industry, and those will be known to persons skilled in the art. The electrodes may be made from conductive materials, for example, metals, and including, but not limited to, precious or base metals, or metal alloys.

In the orientation shown in FIG. 1, the body includes an top or upper surface 30, an opposite bottom or lower surface 32, a first side surface 34 and an opposite second side surface 36.

As shown in FIG. 1, a first terminal 12 is positioned along the first side surface 34, and a second terminal 14 is positioned along the opposite second side surface 36. Each terminal 12, 14 includes portions (12a, 12b, 14a, 14b) that extend at least partially along the upper surface 30 and the lower surface 32, forming surface mount terminal portions or solderable surfaces.

At least some of electrodes 26 extend from and are in electrical communication with the first terminal 12, while other opposing electrodes 26 extend from and are in electrical communication with the second terminal 14.

As shown in FIG. 1, a central group of electrodes are designated as the “Main Block Layers” 40. This group of electrodes creates the capacitance of the MLCC. In examples provided herein, the Main Block Layers may also be referred to as main block layer electrodes, main block electrodes, electrodes of the Main Block Layer, a Main Block Layer and a Main Block, and these terms may be used interchangeably.

The internal electrodes of the Main Block Layers are configured in alternating manners such that one electrode extends from one end of the ceramic capacitor body inwardly toward the terminal on the opposite end of the ceramic capacitor body. The next internal electrode extends from the opposite end of the ceramic capacitor body inwardly toward the terminal on the opposite end of the ceramic body. Each of the electrodes of the Main Block Layer is spaced at a vertical (in the orientation as pictured) distance from an adjacent electrode. That spacing may be uniform, whereby the distance between any two adjacent electrodes of the Main Block Layers is about the same or a similar distance. As shown, the electrodes are arranged essentially parallel.

The Main Block Layers 40 may comprise, for example, multiple electrodes 26 with widths generally almost as wide as the width of the MLCC device. In some devices, a hundred or more electrodes 26 may be present in the Main Block Layers 40. The thickness of the dielectric layer 22 is determined by the voltage at which the device will operate.

The upper-most electrode of the electrodes 26 of the Main Block Layers 40 is position at a vertical distance (as shown in the pictured orientation) L1 from the upper surface 30 of the body 20. It is appreciated that the distance L1 may be selected and/or adjusted based on application needs, uses, specifications, or other requirements.

At least one or more shield electrodes 50 (with two illustrative separate shield electrodes designated as 50a, 50b), are positioned in electrical communication with and extending from one of the terminals. For example, shield electrodes 50a and 50b are shown as extending from the first terminal 12, and partially along the width of the body. In a preferred embodiment, the shield electrodes 50 extend along the body from the first terminal 12 to a distance approximately the same as and/or aligned with corresponding electrodes 26 in the Main Block Layers 40 also extending from the same terminal 12. As shown, the shield electrodes 50a, 50b are arranged essentially parallel to each other, and to the electrodes of the Main Block Layers 40.

The lower-most shield electrode 50a is positioned at a vertical distance (as shown in the pictured orientation) L2 from the lower surface 32 of the body. The distance L2 may preferably be in the range of about 11 micrometers (μm) to about 40 μm. It is appreciated that the distance L2 may be selected and/or adjusted based on application needs, uses, specifications, or other requirements.

The upper-most shield electrode 50b is spaced apart from lower-most electrode 31 of the Main Block Layers 40 by a distance L3. It is appreciated that the distance L3 may be selected and/or adjusted based on application needs, uses, specifications, or other requirements. For example, the distance L3 may be greater than, equal to or less than the distances between adjacent electrodes of the Main Block Layers 40. In addition, the distance L3 may be greater than or equal to the distance L2. That is, the shield electrodes may be closer to the lower surface 32 of the body 20 than to the lower-most of the electrodes 31 of the Main Block Layers 40.

In an arrangement, the distance (L3) from the shield electrode or electrodes to a lower-most electrode 31 of the Main Block Layers 40, is approximately the same as the distance (L2) from the shield electrode or electrodes to the lower surface 32 of the body. In yet another arrangement, the shield electrode or electrodes are spaced at a distance from a lower-most of the plurality of electrodes of the Main Block Layer 40 that is greater than the distance between any two of the plurality of electrodes of the Main Block Layer 40.

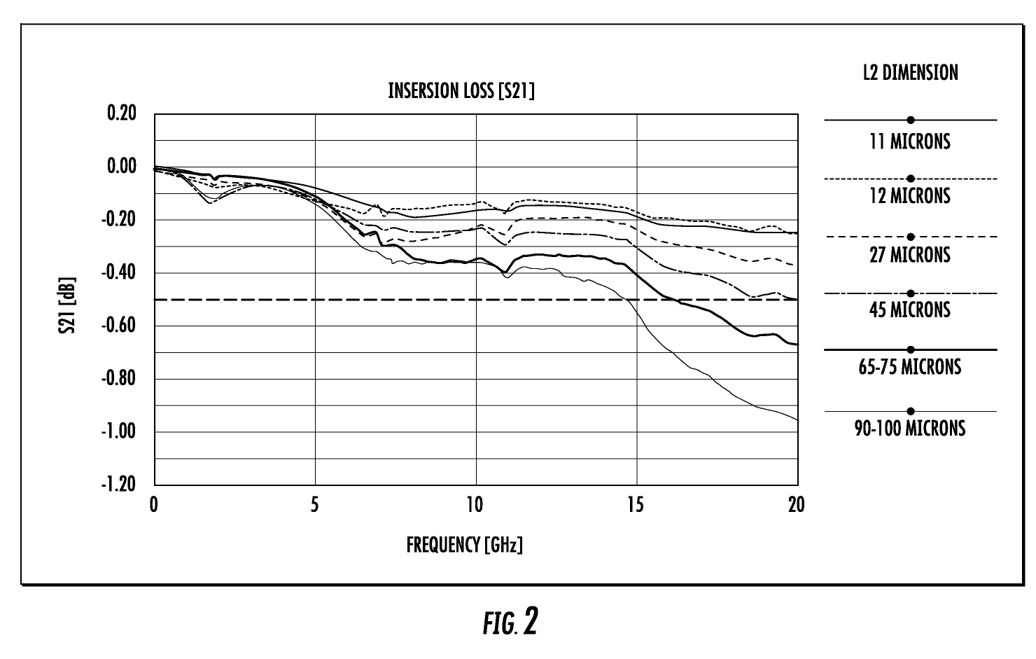

The arrangement of the invention has been shown to exhibit improved properties including enhanced insertion loss characteristics across a desired frequency range. FIG. 2 shows a graph illustrating the impact on wideband insertion loss of a capacitor according to the present invention. As seen in FIG. 2, the horizontal axis represents frequency in terms of GHz and the vertical axis represents insertion loss S21 in terms of dB. L2 distances in microns (or μm) are also shown. The bulk capacitance exhibited by the Main Block Layers 40 has a dominant effect on the low frequency insertion loss S21. The greater the number of electrodes in the Main Block Layers 40 (i.e., higher capacitance), the lower the frequency at which a low insertion loss can be obtained. For example, the greater the number of electrodes in the main block layer 40, the lower the frequency at which less than 0.5 dB insertion loss can be obtained.

At much higher frequencies in the GHz range, complex capacitance, resistive and inductive parasitic elements degrade insertion loss. According to the invention, reducing the distance L2 between the lower-most shield electrode 50a and the lower surface 32 improved the insertion loss S21 at high frequency. This improvement is shown in FIG. 2 where smaller L2 dimensions have more improved insertion loss than larger L2 dimensions.

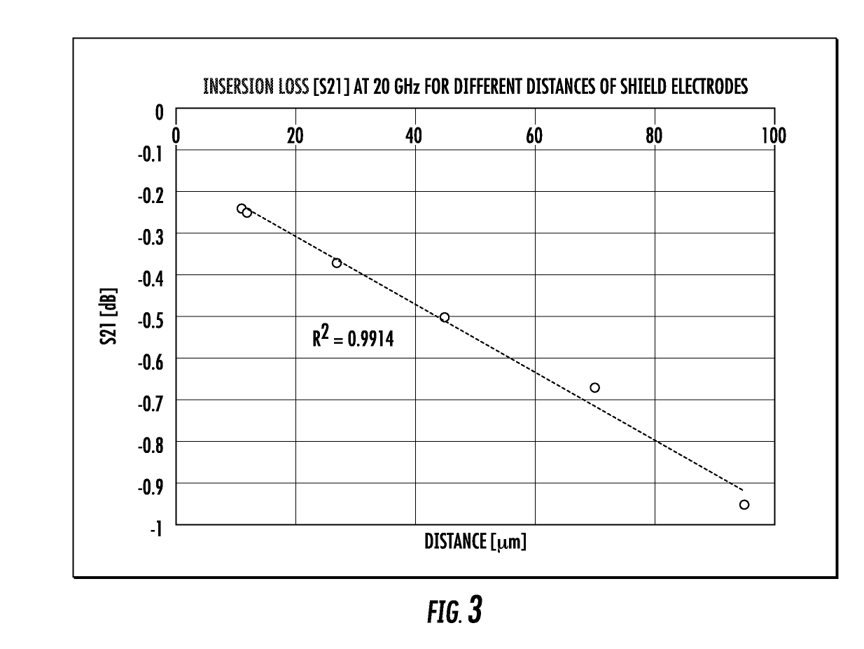

FIG. 3 shows a graph illustrating insertion loss as a function of distance between shield electrodes and the lower surface of the capacitor body. The horizontal axis of FIG. 3 represents L2 distance in terms of μm and the vertical axis represents insertion loss S21 in terms of dB. FIG. 3 shows that the relationship between the distance L2 and insertion loss S21 is almost linear, with a very strong correlation (the correlation coefficient being about R² =0.99). In an example shown in FIG. 3, the insertion loss S21 is measured at 20 GHz. Similar relationships between the distance L2 and insertion loss S21 would apply at other frequencies across the desired frequency range.

It is also appreciated that the positioning of the shield electrodes 50 adjacent the lower surface 32 of the capacitor body creates an inductive loop with respect to the ground plane of a circuit board adjacent which the inventive capacitor is positioned. As a result, a capacitor according to the invention forms an inductive loop by lower-most shield electrode 50a with respect to a microstrip plane. Accordingly, the inductive effect of a current loop may be reduced by reducing the distance L2. Thus, the inductive effect is reduced by reducing the distance L2 between the shield electrodes 50 and the lower surface 32 of the capacitor body. Consequently, insertion loss is improved.

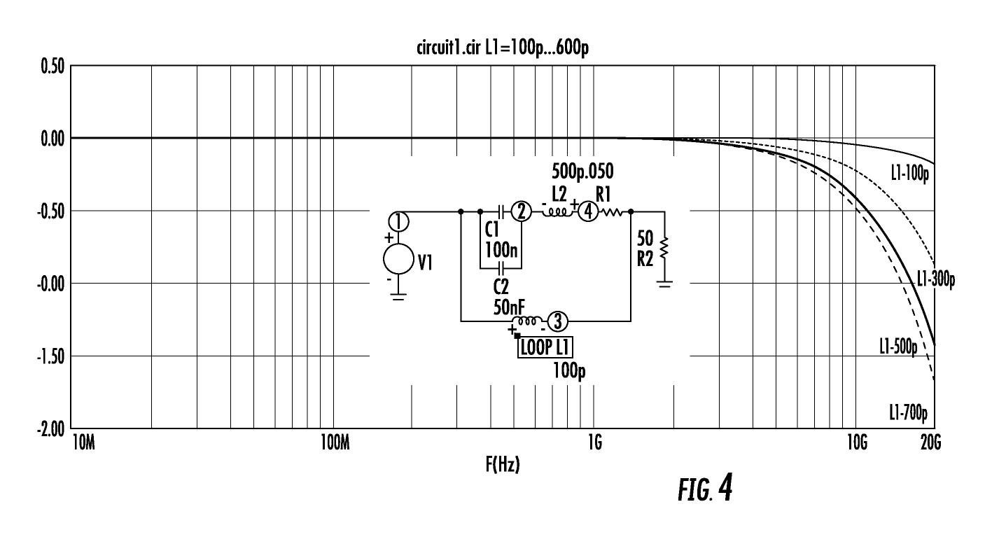

FIG. 4 shows the effect of loop inductance simulated as a parallel element across a series capacitor model. As seen in FIG. 4, the horizontal axis represents frequency in terms of Hz and the vertical axis represents insertion loss S21 in terms of dB. A frequency plot shows that reducing the loop inductance has the effect of reducing insertion loss and extending broad band range. Reducing the loop inductance may be done by stepping the loop inductance down. The frequency plot may be generated by setting a range of stepped down inductances.

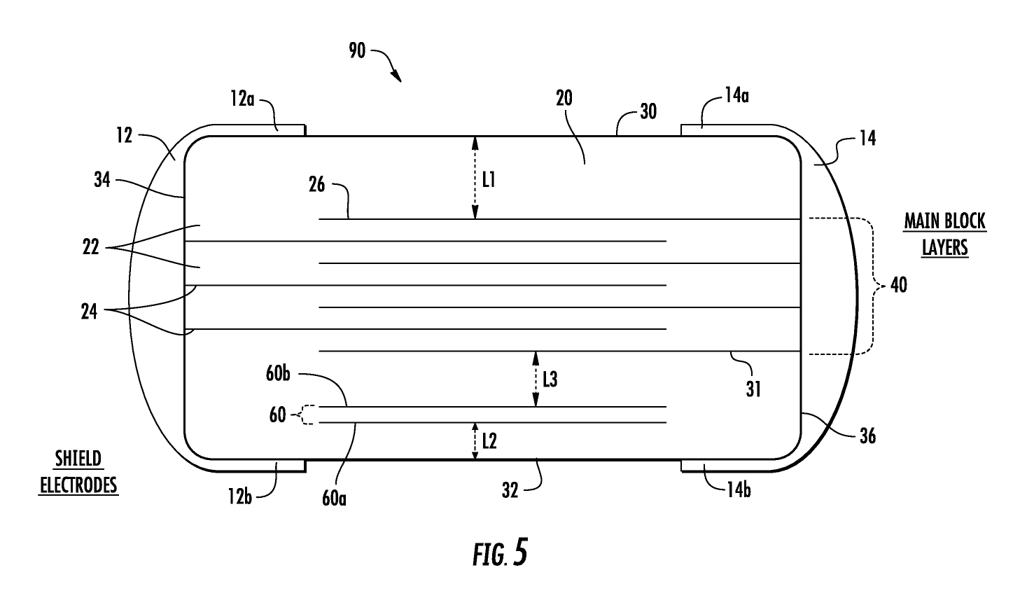

In another embodiment of a multilayer ceramic capacitor 90, as shown in FIG. 5, the shield electrodes 60 (individually designated as 60a and 60b) may not be in electrical communication with either of the terminals 12, 14, and may be considered to be “floating” (e.g., unattached or not connected) within the capacitor body. As shown, the floating shield electrodes 60a, 60b may be positioned generally centrally within the body 20 of the capacitor 90. The design of the multilayer ceramic capacitor of FIG. 5 may otherwise be similar to the embodiment shown in FIG. 1.

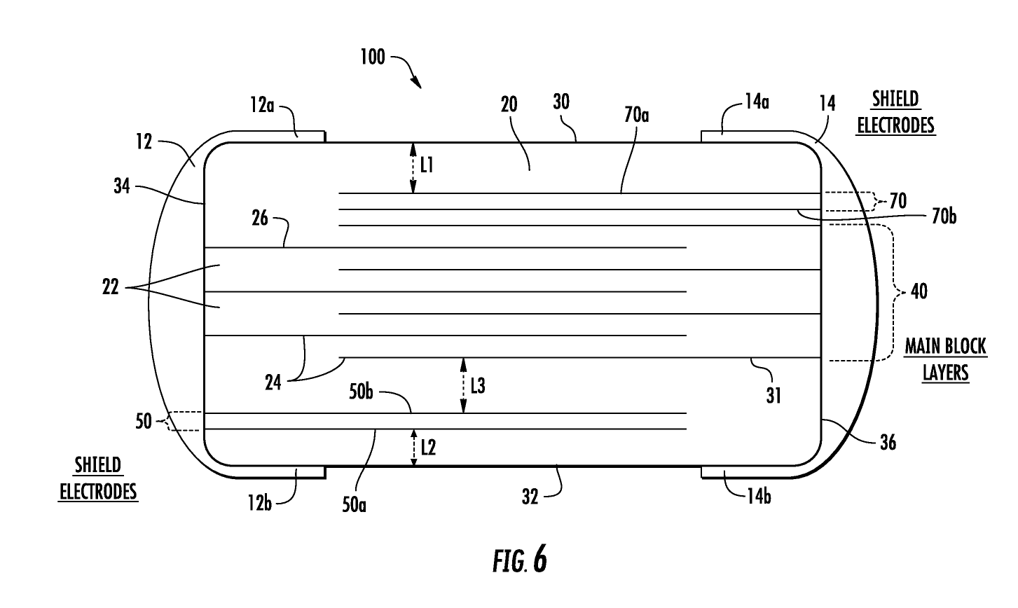

In another embodiment, as shown in FIG. 6, a multilayer ceramic capacitor 100 may include a plurality of shield electrodes provided adjacent both the top 30 and bottom 32 surfaces of the body 20, and both above and below the Main Block Layers 40. Accordingly, upper shield electrodes 70 (individually designated as 70a and 70b) are positioned adjacent the top of the Main Block Layers 40. Note that the distance L1 in FIG. 6 is the distance from the upper-most shield electrode 70a to the top surface 30 of the body 20 of the capacitor 100. The design of the multilayer ceramic capacitor of FIG. 6 may otherwise be similar to the embodiment shown in FIG. 1.

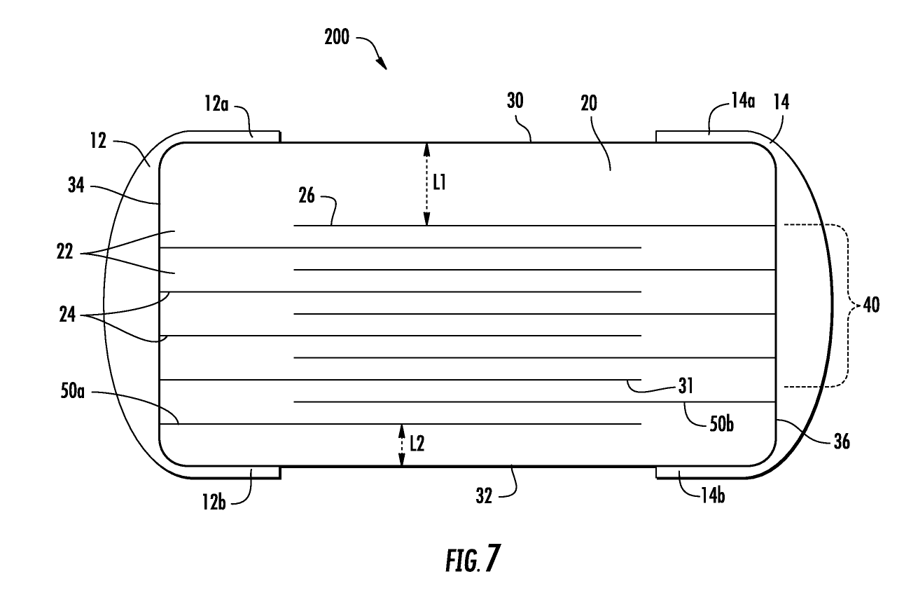

In another embodiment, as shown in FIG. 7, a multilayer ceramic capacitor 200 may include one or more shield electrodes 50a, 50b separated from each other by a dimension (distance) approximately equal to the separation dimension between the electrodes 26 that comprise the Main Block 40, and with the upper shield electrode 50b separated from the electrodes 26 that comprise the Main Block 40 by a dimension (distance) approximately equal to the separation dimension between the electrodes 26 that comprise the Main Block 40. Thus, each electrode is separated from an adjacent electrode by approximately the same or a similar distance, rather than a greater separation between the Main Block electrodes and the shield electrodes as in other embodiments. The distance L2 from the lower shield electrode 50a to the bottom surface 32 may be less than the distance L1 from the uppermost electrode of the Main Block 40 to the upper surface 30. The design of the multilayer ceramic capacitor of FIG. 7 may otherwise be similar to the embodiment shown in FIG. 1.

It is appreciated that the MLCC capacitors may be of different case sizes as are known in the art, for example, but not limited to, case sizes 0201, 0402, 0505, 0603, 0805, 1111, 1206, 1210, 1812, 1825, 2525, 3640 and 3838.

According to an example aspect of the present invention, a multilayer ceramic capacitor is provided which includes a body comprising a top surface, a bottom surface, first and second opposite ends, and a plurality of electrode layers and dielectric layers. The capacitor also includes first and second terminals attached to the first and second ends of the body. Further, the capacitor includes a plurality of main block layer electrodes within the ceramic capacitor body configured in an alternating manner such that a first of the plurality of main block layer electrodes is in electrical communication with the first terminal and extends from one end of the ceramic capacitor body inwardly, and a next of the plurality of main block layer electrodes is in electrical communication with the second terminal and extends from an opposite end of the ceramic capacitor body inwardly. In addition, the capacitor includes at least one first shield electrode in electrical communication with the first terminal and extending from the first end of the ceramic capacitor body inwardly, the first shield electrode positioned between the main block layer electrodes and a lower surface of the body.

In a further example, the capacitor has a low insertion loss of approximately S21<0.5 dB over a wideband frequency range of about 16 kHz to about 40 GHz or greater. Alternatively, the capacitor has a low insertion loss of approximately S21<0.5 dB over a wideband frequency range of about 28 kHz to about 20 GHz. Further, the first shield electrode may be positioned closer to the lower surface of the body than to a lower-most of the plurality of main block layer electrodes. In addition, the distance from the first shield electrode to a lower-most of the plurality of main block layer electrodes may be approximately the same as the distance from the first shield electrode to the lower surface of the body. Moreover, the first shield electrode may be spaced at a distance from a lower-most of the plurality of electrodes that is greater than the distance between any two of the plurality of electrodes of the main block layer. Additionally, the first shield electrode may be spaced at a distance from a lower-most of the plurality of electrodes that is the same or similar to the distance between any two of the plurality of electrodes of the main block layer.

In another example, the capacitor has a second shield electrode in electrical communication with the first terminal and extending from the first end of the ceramic capacitor body inwardly, the second shield electrode positioned between the main block layer electrodes and the first shield electrode. The second shield electrode may be positioned closer to the first shield electrode than to the main block layer electrodes.

In still another example, the capacitor has a third shield electrode in electrical communication with the second terminal and extending from the second end of the ceramic capacitor body inwardly, the third shield electrode positioned between the main block layer electrodes and the top surface of the body. In yet another example, the capacitor has a fourth electrode in electrical communication with the second terminal and extending from the second end of the ceramic capacitor body inwardly, the second fourth electrode positioned between the third shield electrode and the top surface of the body.

According to another aspect of the present invention a method of manufacturing a multilayer ceramic component is provided. The method includes forming a ceramic capacitor body from a plurality of electrode layers and dielectric layers and attaching first and second external terminals on opposite ends of the ceramic capacitor body. The plurality of electrode layers are configured in an alternating manner such that a first of the plurality of active electrodes extends from one end of the ceramic capacitor body inwardly and a next internal active electrode extends from an opposite end of the ceramic capacitor body inwardly. At least one first shield electrode is provided, and may be extending from one of the terminals inwardly. The first shield electrode is spaced at a distance from the plurality of electrode layers, and is positioned adjacent a surface of the capacitor body.

It will be appreciated that the foregoing is presented by way of illustration only and not by way of any limitation. It is contemplated that various alternatives and modifications may be made to the described embodiments without departing from the spirit and scope of the invention. Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A multilayer ceramic capacitor comprising:
a body comprising a top surface, a bottom surface, and first and second opposite ends, and comprised of a plurality of electrode layers and dielectric layers;
first and second terminals attached to the first and second ends of the body;
a plurality of main block layer electrodes within the ceramic capacitor body configured in an alternating manner such that a first of the plurality of main block layer electrodes is in electrical communication with the first terminal and extends from one end of the ceramic capacitor body inwardly, and a next of the plurality of main block layer electrodes is in electrical communication with the second terminal and extends from an opposite end of the ceramic capacitor body inwardly; and
at least one first shield electrode in electrical communication with the first terminal and extending from the first end of the ceramic capacitor body inwardly, the first shield electrode positioned between the main block layer electrodes and a lower surface of the body.

2. The multilayer ceramic capacitor of claim 1, wherein the capacitor has a low insertion loss of approximately S21<0.5 dB over a wideband frequency range of about 16 kHz to about 40 GHz or greater.

3. The multilayer ceramic capacitor of claim 1, wherein the capacitor has a low insertion loss of approximately S21<0.5 dB over a wideband frequency range of about 28 kHz to about 20 GHz.

4. The multilayer ceramic capacitor of claim 1, wherein the first shield electrode is positioned closer to the lower surface of the body than to a lower-most of the plurality of main block layer electrodes.

5. The multilayer ceramic capacitor of claim 1, wherein the distance from the first shield electrode to a lower-most of the plurality of main block layer electrodes is approximately the same as the distance from the first shield electrode to the lower surface of the body.

6. The multilayer ceramic capacitor of claim 1, wherein the first shield electrode is spaced at a distance from a lower-most of the plurality of electrodes that is greater than the distance between any two of the plurality of electrodes of the main block layer.

7. The multilayer ceramic capacitor of claim 1, wherein the first shield electrode is spaced at a distance from a lower-most of the plurality of electrodes that is the same or similar to the distance between any two of the plurality of electrodes of the main block layer.

8. The multilayer ceramic capacitor of claim 1, further comprising a second shield electrode in electrical communication with the first terminal and extending from the first end of the ceramic capacitor body inwardly, the second shield electrode positioned between the main block layer electrodes and the first shield electrode.

9. The multilayer ceramic capacitor of claim 6, wherein the second shield electrode is positioned closer to the first shield electrode than to the main block layer electrodes.

10. The multilayer ceramic capacitor of claim 1, further comprising a third shield electrode in electrical communication with the second terminal and extending from the second end of the ceramic capacitor body inwardly, the third shield electrode positioned between the main block layer electrodes and the top surface of the body.

11. The multilayer ceramic capacitor of claim 10, further comprising a fourth electrode in electrical communication with the second terminal and extending from the second end of the ceramic capacitor body inwardly, the fourth electrode positioned between the third shield electrode and the top surface of the body.

12. A method of forming a multilayer ceramic capacitor, the method comprising:
forming a ceramic body comprising a top surface, a bottom surface, and first and second opposite ends and comprised of a plurality of electrode layers and dielectric layers;
forming first and second terminals attached to the first and second ends of the body;
forming a plurality of main block layer electrodes within the ceramic capacitor body configured in an alternating manner such that a first of the plurality of main block layer electrodes is in electrical communication with the first terminal and extends from one end of the ceramic capacitor body inwardly, and a next of the plurality of main block layer electrodes is in electrical communication with the second terminal and extends from an opposite end of the ceramic capacitor body inwardly; and
forming at least one first shield electrode in electrical communication with the first terminal and extending from the first end of the ceramic capacitor body inwardly, the first shield electrode positioned between the main block layer electrodes and a lower surface of the body.

13. The method of claim 12, wherein the capacitor has a low insertion loss of approximately S21<0.5 dB over a wideband frequency range of about 16 kHz to about 40 GHz or greater.

14. The method of claim 12, wherein the capacitor has a low insertion loss of approximately S21<0.5 dB over a wideband frequency range of about 28 kHz to about 20 GHz.

15. The method of claim 12, wherein the first shield electrode is positioned closer to the lower surface of the body than to a lower-most of the plurality of main block layer electrodes.

16. The method of claim 12, wherein the distance from the first shield electrode to a lower-most of the plurality of main block layer electrodes is approximately the same as the distance from the first shield electrode to the lower surface of the body.

17. The method of claim 12, wherein the first shield electrode is spaced at a distance from a lower-most of the plurality of electrodes that is greater than the distance between any two of the plurality of electrodes of the main block layer.

18. The method of claim 12, wherein the first shield electrode is spaced at a distance from a lower-most of the plurality of electrodes that is the same or similar to the distance between any two of the plurality of electrodes of the main block layer.

19. The method of claim 12, further comprising:
forming a second shield electrode in electrical communication with the first terminal and extending from the first end of the ceramic capacitor body inwardly, the second shield electrode positioned between the main block layer electrodes and the first shield electrode.

20. The method of claim 12, further comprising:
forming a third shield electrode in electrical communication with the second terminal and extending from the second end of the ceramic capacitor body inwardly, the third shield electrode positioned between the main block layer electrodes and the top surface of the body.
